(19) United States
(12) Patent Application Publication
(10) Pub. No.: US 2026/0368114 A1
(43) Pub. Date: Nov. 19, 2026

(54) ELECTRONIC APPARATUS AND CONTROL METHOD FOR MANAGING POINTERS

(71) Applicant: Realtek Semiconductor Corporation, Hsinchu (TW)

(72) Inventors: Ying-Sheng TSAI, Hsinchu (TW); Jen-Che TSAI, Hsinchu (TW); Shiao-Yang WU, Hsinchu (TW)

(21) Appl. No.: 19/647,845

(22) Filed: Apr. 14, 2026

(30) Foreign Application Priority Data
May 15, 2025 (TW) 114118332

(51) Int. Cl. G06F 13/28

(52) U.S. Cl. CPC G06F 13/28; G06F 2213/28

(57) ABSTRACT

An electronic apparatus includes a data memory, a direct memory access controller, a processing unit, a buffer memory, and a buffer manager. The buffer manager includes a register configured to temporarily store a plurality of pointers. The pointers are configured to indicate respective start addresses of packet buffer spaces. The buffer manager is configured to manage the pointers and monitor a number of available pointers in the register. The processing unit is configured to write an initial state value into a pop block of the data memory and sends a pop command to the buffer manager. In response to the pop command, when the buffer manager determines that the number of available pointers is insufficient, the buffer manager is configured to write a first state value and a pause time into the pop block via the direct memory access controller.

### CROSS-REFERENCE TO RELATED APPLICATIONS

This application claims the priority benefit of Taiwan patent application number 114118332, filed on May 15, 2025, which is hereby incorporated by reference herein and made a part of this specification.

### BACKGROUND

### Field of Invention

The present disclosure relates to a control method and an electronic apparatus for managing pointers, and more particularly, to a control method and an electronic apparatus for managing available pointers of a packet buffer.

### Description of Related Art

Electronic apparatuses with communication functions typically include a processor and communication circuitry. The processor primarily handles data processing tasks, while the communication circuitry manages communications with external devices, including the reception and transmission of packets.

Generally, packets are temporarily stored in a packet buffer. For instance, input packets received via the communication circuitry are stored in the packet buffer. The processor can read these input packets from a specific address in the packet buffer. Conversely, when the processor generates output packets for external transmission, it also stores them in the packet buffer. The communication circuitry then retrieves and sends these packets from their designated address in the buffer.

Consequently, effective management of packet buffer allocation and deallocation is crucial. One conventional approach involves the processor and the communication circuitry polling each other to determine the current buffer usage status. However, such frequent polling consumes valuable bus bandwidth.

Another approach utilizes specific ready signals to convey the buffer's status. For example, a ready signal might indicate whether the communication circuitry has completed a prior transmission or reception task. If a ready signal (e.g., an RREADY signal or a WVALID signal) has not transitioned to a completion level, the processor must wait. This method is a form of back-pressure flow control. While effective at indicating current buffer occupancy, it lacks predictive flow capabilities and is susceptible to head-of-line blocking. If a single task takes an extended time and fails to update the ready signal, the processor is blocked from smoothly accessing the packet buffer, which hinders its ability to process other tasks in parallel.

### SUMMARY

An aspect of the present disclosure provides an electronic apparatus including a data memory, a direct memory access controller, a processing unit, a buffer memory, and a buffer manager. The direct memory access controller is coupled to the data memory. The processing unit is coupled to the data memory. The buffer memory has a plurality of packet buffer spaces, wherein the packet buffer spaces are respectively aligned with a packet size. The buffer manager comprises a register for temporarily storing a plurality of pointers, the plurality of pointers being for indicating respective start addresses in the plurality of packet buffer spaces. The buffer manager is for managing the pointers and monitoring a number of available pointers in the register. The processing unit writes an initial state value into a pop block of the data memory and sends a pop command to the buffer manager. In response to the pop command, when the buffer manager determines that the number of available pointers is insufficient, the buffer manager writes a first state value and a pause time into the pop block via the direct memory access controller.

Another aspect of the present disclosure provides a control method including: writing, by a processing unit, an initial state value into a pop block of a data memory, and sending, by the processing unit, a pop command to a buffer manager; in response to the pop command, determining, by the buffer manager, whether a number of available pointers in a register is sufficient; and when the buffer manager determines that the number of available pointers is insufficient, writing, by the buffer manager, a first state value and a pause time into the pop block via a direct memory access controller.

Another aspect of the present disclosure provides a control method including: writing, by a processing unit, an initial state value and a partial pointer address of a current pointer into a push block of a data memory, and sending, by the processing unit, a push command to a buffer manager; in response to the push command, determining, by the buffer manager, whether a number of remaining spaces in a register is sufficient; and when the buffer manager determines that the number of remaining spaces is insufficient, writing, by the buffer manager, a first state value and a pause time into the push block via a direct memory access controller.

It is to be understood that both the foregoing general description and the following detailed description are exemplary and explanatory only and are not restrictive of the disclosure, as claimed.

### BRIEF DESCRIPTION OF THE DRAWINGS

The disclosure can be more fully understood by reading the following detailed description of the embodiment, with reference made to the accompanying drawings as follows.

FIG. 1 is a functional block diagram of an electronic apparatus according to some embodiments of the present disclosure.

FIG. 2 is a flowchart of a control method employed when the processing unit in FIG. 1 requires a buffer space and sends a pop command to the buffer manager.

FIG. 3A is a schematic diagram illustrating the processing unit writing an initial state value into a pop block of the data memory.

FIG. 3B is a schematic diagram illustrating the buffer manager writing to the pop block when the number of available pointers in the register is insufficient.

FIG. 3C is a schematic diagram illustrating the buffer manager writing to the pop block when the number of available pointers in the register is sufficient.

FIG. 3D is a schematic diagram illustrating the buffer manager writing to the pop block again when the number of available pointers in the register is sufficient.

FIG. 4 is a flowchart of a control method employed when the processing unit in FIG. 1 intends to release a buffer space and sends a push command to the buffer manager.

FIG. 5A is a schematic diagram illustrating the processing unit writing an initial state value and a partial pointer address of a current pointer to be returned into a push block of the data memory.

FIG. 5B is a schematic diagram illustrating the buffer manager writing to the push block when the number of remaining spaces in the register is insufficient.

FIG. 5C is a schematic diagram illustrating the buffer manager writing to the push block when the number of remaining spaces in the register is sufficient.

FIG. 5D is a schematic diagram illustrating the processing unit writing an initial state value and a partial pointer address of a subsequent current pointer to be returned into the push block of the data memory.

FIG. 5E is a schematic diagram illustrating the buffer manager writing to the push block when the number of remaining spaces in the register is sufficient.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In the drawings, the same reference numerals are used to designate the same or similar elements.

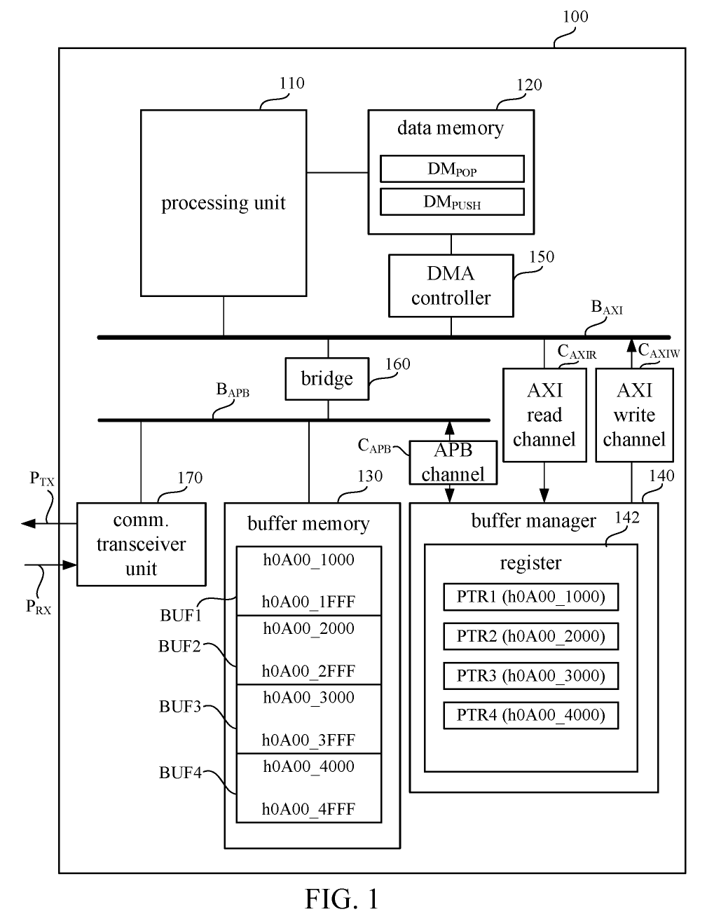

Reference is made to FIG. 1, which is a functional block diagram illustrating an electronic apparatus 100 according to some embodiments of the present disclosure. As shown in FIG. 1, the electronic apparatus 100 includes a processing unit 110, a data memory 120, a buffer memory 130, a buffer manager 140, a direct memory access (DMA) controller 150, a bridge 160, and a communication transceiver unit 170.

In one embodiment, the electronic apparatus 100 can be a device with communication capabilities, such as a computer, a smartphone, a network switch, a gateway, or a router. The electronic apparatus 100 can send an outbound transmit packet P_{TX} to an external network via the communication transceiver unit 170. On the other hand, the electronic apparatus 100 can receive an inbound receive packet P_{RX} from the external network via the communication transceiver unit 170. Thereby, the electronic apparatus 100 can exchange data with other devices on the external network through the communication transceiver unit 170.

In one embodiment, the communication transceiver unit 170 can include an Ethernet transceiver circuit, a Wi-Fi transceiver circuit, a Bluetooth transceiver circuit, or other communication transceiver circuits. In another embodiment, the communication transceiver unit 170 can also include communication interfaces for transmitting audio-visual data, such as a High Definition Multimedia Interface (HDMI) transmission circuit or a Digital Visual Interface (DVI).

In some embodiments, the communication transceiver unit 170 may be implemented by hardware of the aforementioned transceiver circuits or communication interfaces. In other embodiments, the communication transceiver unit 170 may be implemented by logic circuits within a System-on-Chip (SoC) executing software/firmware related to the aforementioned communication functions.

The processing unit 110 in the electronic apparatus 100 is responsible for data processing tasks on the electronic apparatus 100. For example, the processing unit 110 processes a user's voice input, generates corresponding audio packets, and transmits them. On the other hand, the processing unit 110 can also decode received audio packets and play them on the device. In one embodiment, the processing unit 110 can be implemented by a processor, a central processing unit (CPU), a graphics processing unit (GPU), a tensor processing unit (TPU), an application-specific integrated circuit (ASIC), or other similar processing circuits.

In some embodiments, the operating clocks used by the processing unit 110 and the communication transceiver unit 170 may be different. The processing unit 110 typically uses a higher operating clock for fast and efficient computation. Due to the different operating clocks, it is not suitable for the inbound receive packet P_{RX} received by the communication transceiver unit 170 to be directly transmitted to the processing unit 110. Similarly, it is not suitable for the outbound transmit packet P_{TX} generated by the processing unit 110 to be directly transmitted to the communication transceiver unit 170. In this embodiment, the outbound transmit packet P_{TX} and the inbound receive packet P_{RX} are temporarily stored in the buffer memory 130. The processing unit 110 and the communication transceiver unit 170 respectively write to or read from the buffer memory 130 to access the outbound transmit packet P_{TX} and the inbound receive packet P_{RX}.

As shown in FIG. 1, the buffer memory 130 has a plurality of packet buffer spaces BUF1-BUF4. Each packet buffer space BUF1-BUF4 can be used to store a single outbound transmit packet P_{TX} or a single inbound receive packet P_{RX}. It should be noted that the buffer memory 130 can include a larger number of packet buffer spaces. For simplicity of explanation, FIG. 1 exemplarily shows four packet buffer spaces BUF1-BUF4, but the present disclosure is not limited to this number of packet buffer spaces.

In some embodiments, for convenience of transmission, the outbound transmit packet P_{TX} and the inbound receive packet P_{RX} have a fixed packet size. In this case, the boundaries of these packet buffer spaces BUF1-BUF4 in the buffer memory 130 are respectively aligned with the fixed packet size to improve the space utilization efficiency of the buffer memory 130.

Taking the embodiment shown in FIG. 1 as an example, the packet buffer space BUF1 is located between the hexadecimal start address h0A00_1000 and the end address h0A00_1FFF. The packet buffer space BUF2 is located between the hexadecimal start address h0A00_2000 and the end address h0A00_2FFF. Similarly, the packet buffer space BUF4 is located between the hexadecimal start address h0A00_4000 and the end address h0A00_4FFF.

In one embodiment, the buffer manager 140 is used to manage the packet buffer spaces BUF1-BUF4 in the buffer memory 130, assigning them to the corresponding processing unit 110 or communication transceiver unit 170. In some applications, the buffer manager 140 is implemented by a free buffer manager (FBM) circuit, an application-specific integrated circuit (ASIC), or a microcontroller. In other applications, the buffer manager 140 can be implemented by logic circuits within a System-on-Chip (SoC) executing relevant software/firmware.

In the embodiment shown in FIG. 1, the buffer manager 140 includes a register 142 for temporarily storing at least one available pointer. Each available pointer is used to indicate the start address of one of the packet buffer spaces in the buffer memory 130. The buffer manager 140 manages the number of available pointers in the register 142 and allocates at least one available pointer to the processing unit 110 and the communication transceiver unit 170.

In the example of FIG. 1, the register 142 currently stores four available pointers PTR1-PTR4. Pointer PTR1 indicates the start address h0A00_1000 of the packet buffer space BUF1; pointer PTR2 indicates the start address h0A00_2000 of the packet buffer space BUF2; pointer PTR3 indicates the start address h0A00_3000 of the packet buffer space BUF3; and pointer PTR4 indicates the start address h0A00_4000 of the packet buffer space BUF4.

The buffer manager 140 manages the number of available pointers in the register 142 (which is 4 at this time in the example of FIG. 1) and allocates pointers PTR1-PTR4 to functional circuits that need them, such as the processing unit 110.

In the example shown in FIG. 1, each packet buffer space BUF1-BUF4 has the same packet size, so the start addresses of each packet buffer space BUF1-BUF4 are separated by a hexadecimal value of h1000, which is an interval of 12 bits. In this case, the start addresses recorded by the different pointers PTR1-PTR4 are also separated by h1000.

For example, pointer PTR1 indicates the start address h0A00_1000 of the packet buffer space BUF1, pointer PTR2 indicates the start address h0A00_2000 of the packet buffer space BUF2, and pointer PTR3 indicates the start address h0A00_3000 of the packet buffer space BUF3. In such a case, the full address length of different available pointers is 32 bits. Among them, the 4 bits near the most significant bit (MSB) are also a fixed value, fixed at h0. On the other hand, the 12 bits near the least significant bit (LSB) are a fixed value, fixed at h000. That is to say, different available pointers only carry the effective address in the middle 16 bits.

In one embodiment, the buffer manager 140, the processing unit 110, and the communication transceiver unit 170 can be implemented by logic circuits within the same System-on-Chip executing relevant software/firmware. In another embodiment, the buffer manager 140, the processing unit 110, and the communication transceiver unit 170 can be implemented by different hardware components (e.g., a System-on-Chip, a CPU, and a network transceiver circuit, respectively).

As shown in FIG. 1, the electronic apparatus 100 further includes an Advanced eXtensible Interface (AXI) bus B_{AXI} and an Advanced Peripheral Bus (APB) B_{APB}. A bridge 160 is coupled between the AXI bus B_{AXI} and the advanced peripheral bus B_{APB}.

In the embodiment shown in FIG. 1, the processing unit 110 and the data memory 120 are coupled to the AXI bus B_{AXI} and can indirectly connect to the advanced peripheral bus B_{APB} through the bridge 160.

On the other hand, the buffer memory 130 and the communication transceiver unit 170 are coupled to the advanced peripheral bus B_{APB} and can indirectly connect to the AXI bus B_{AXI} through the bridge 160.

In this embodiment, the buffer manager 140 has an APB channel C_{APB} for connecting to the advanced peripheral bus B_{APB}. The buffer manager 140 has an AXI read channel C_{AXIR} and an AXI write channel C_{AXIW} for connecting to the AXI bus B_{AXI}.

When the processing unit 110 sends a request command to the buffer manager 140 to request the use of a packet buffer space, the buffer manager 140 pops an available pointer from the register 142 and allocates it to the processing unit 110. When the processing unit 110 finishes using the packet buffer space, the buffer manager 140 can push the corresponding available pointer back into the register 142, thereby releasing the packet buffer space for subsequent use. The detailed process of popping and pushing pointers will be fully described in the subsequent embodiments.

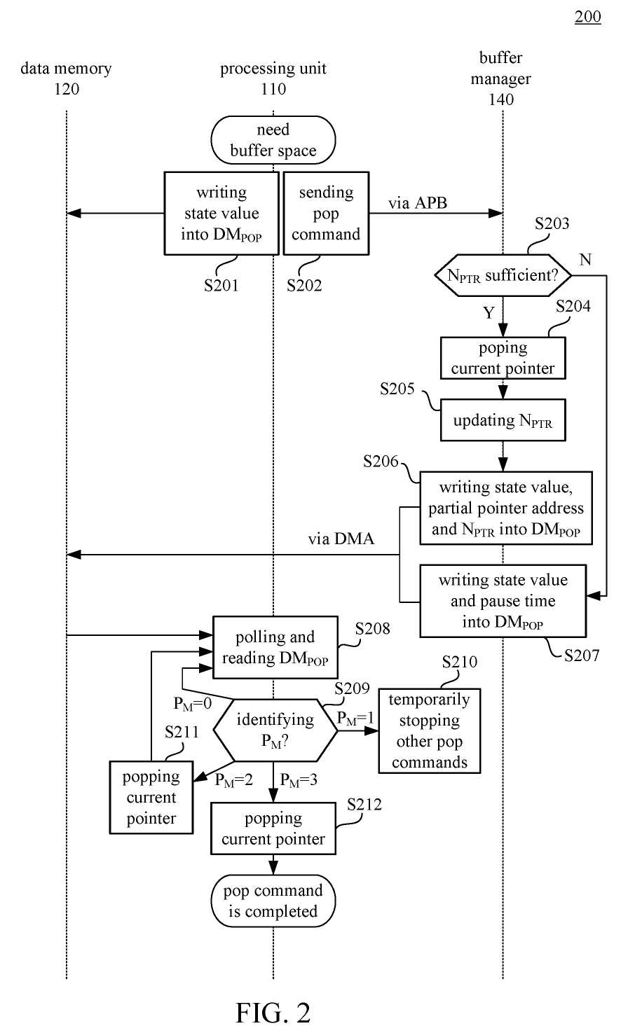

Reference is further made to FIG. 2, which is a flowchart illustrating a control method 200 employed when the processing unit 110 in FIG. 1 requires a buffer space and sends a pop command to the buffer manager 140.

When the processing unit 110 needs a buffer space, the processing unit 110 sends a request to the buffer manager 140 to pop an available pointer.

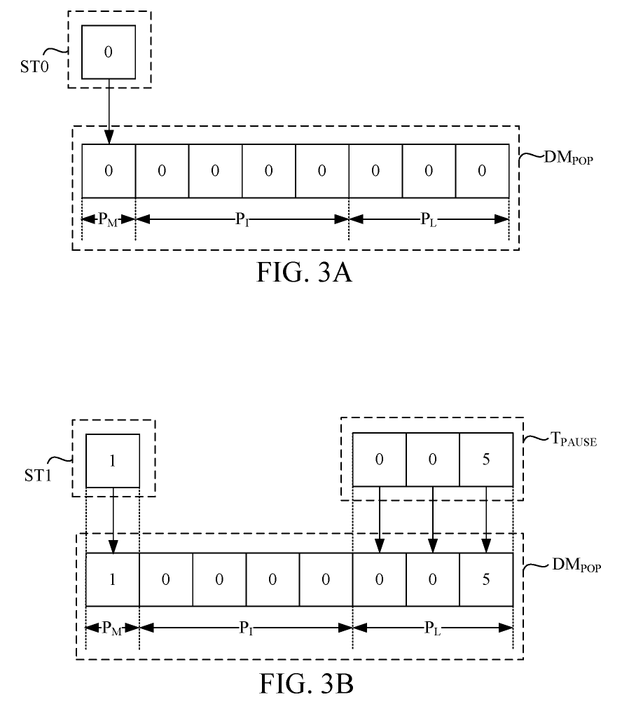

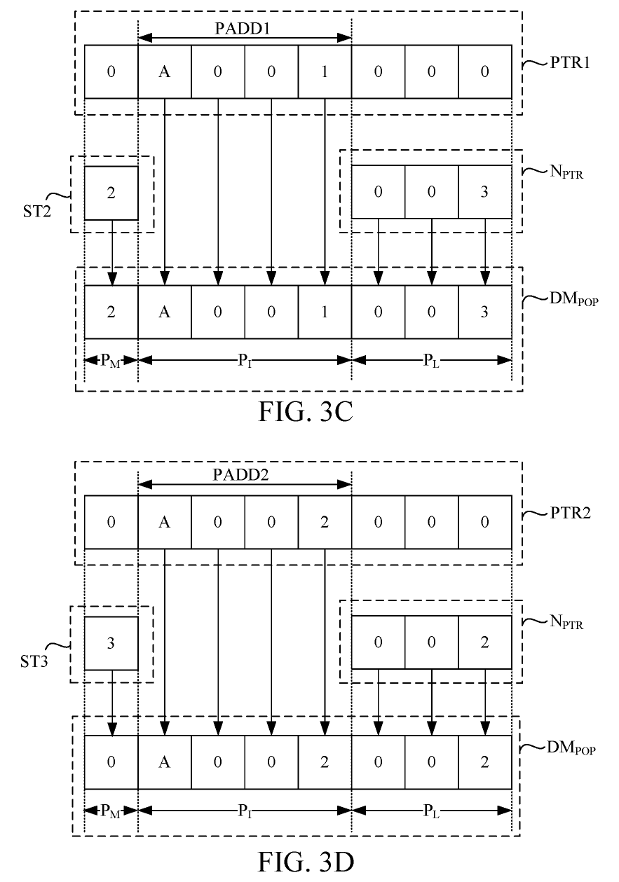

In step S201, the processing unit 110 writes an initial state value into a pop block DM_{POP} of the data memory 120. Reference is further made to FIG. 3A, which is a schematic diagram illustrating the processing unit 110 writing an initial state value ST0 into the pop block DM_{POP} of the data memory 120. As shown in FIG. 3A, the processing unit 110 writes the initial state value ST0 (in this embodiment, the value of the initial state value ST0 is 0) into a high-bit portion P_{M} of the pop block DM_{POP}.

In step S202, the processing unit 110 sends a pop command to the buffer manager 140. It is assumed here that the processing unit 110 needs to use two packet buffer spaces, so the pop command can be a burst pop command to sequentially pop two available pointers.

In one embodiment, this pop command is sent from the processing unit 110 to the buffer manager 140 through the AXI bus B_{AXI}, the bridge 160, the advanced peripheral bus B_{APB}, and via the APB channel C_{APB}.

When the buffer manager 140 receives the pop command, the buffer manager 140 performs step S203 to determine whether the number of available pointers N_{PTR} in the current register 142 is sufficient.

At this time, assume that the buffer manager 140 determines that the number of available pointers N_{PTR} in the register 142 is insufficient (e.g., all available pointers have been used, N_{PTR}=0). In this hypothetical situation, reference is further made to FIG. 3B, which is a schematic diagram illustrating the buffer manager 140 writing to the pop block DM_{POP} when the number of available pointers N_{PTR} in the register 142 is insufficient. As shown in FIGS. 1 and 3B, when the buffer manager 140 determines that the number of available pointers N_{PTR} is insufficient, the buffer manager 140 performs step S207, writing a first state value ST1 and a pause time T_{PAUSE} into the pop block DM_{POP} of the data memory 120 via the DMA controller 150 through the AXI write channel C_{AXIW}. The buffer manager 140 writes the first state value ST1 into the high-bit portion P_{M} of the pop block DM_{POP} and writes the pause time T_{PAUSE} into a low-bit portion P_{L} of the pop block DM_{POP}. The pop block DM_{POP} is updated with the write from the DMA controller 150.

In this embodiment, after the processing unit 110 sends the pop command (via the advanced peripheral bus B_{APB} and the APB channel C_{APB}), the processing unit 110 does not need to poll the advanced peripheral bus B_{APB} or wait for the buffer manager 140 to respond via the APB channel C_{APB} on whether the pop was successful. After sending the pop command, the processing unit 110 can perform step S208, where the processing unit 110 polls and reads the pop block DM_{POP} of the data memory 120. It then performs step S209 to identify the value of the high-bit portion P_{M} of the pop block DM_{POP}.

In one embodiment, the processing unit 110 and the data memory 120 have a direct message exchange channel, and the processing unit 110 and the data memory 120 can also communicate via the AXI bus B_{AXI}, without needing to communicate through the advanced peripheral bus B_{APB}. In one embodiment, the processing unit 110 sends the pop command to the buffer manager 140 via the advanced peripheral bus B_{APB}. A first speed at which the processing unit 110 polls and reads the pop block DM_{POP} of the data memory 120 (typically requiring only one system clock cycle) is higher than a second speed at which the processing unit 110 polls and reads the advanced peripheral bus B_{APB} (typically requiring 2-10 system clock cycles). Therefore, by using the value of the high-bit portion P_{M}, the processing unit 110 can more efficiently learn the processing status of the current pop command, without being affected by the advanced peripheral bus B_{APB} being occupied with transmitting other information.

If in step S209, the processing unit 110 identifies the value of the high-bit portion P_{M} of the pop block DM_{POP} as 0, which is equal to the initial state value ST0 (see FIG. 3A), it indicates that the pop command is still in the initial stage and the buffer manager 140 has not yet responded.

If in step S209, the processing unit 110 identifies the value of the high-bit portion P_{M} of the pop block DM_{POP} as 1, which is equal to the first state value ST1 (see FIG. 3B), it indicates that the buffer manager 140 has responded that the number of available pointers N_{PTR} is insufficient and cannot meet the demand of the pop command. At this time, the processing unit 110 performs step S210 for suspending/pausing the transmission of other pop commands according to the pause time T_{PAUSE} recorded in the low-bit portion P_{L} of the pop block DM_{POP}. In the embodiment of FIG. 3B, the pause time T_{PAUSE} is 5, indicating that the buffer manager 140 has replied with a request for the processing unit 110 to wait for 5 units of system time. Through this mechanism, the buffer manager 140 can proactively respond to the situation of an insufficient number of available pointers N_{PTR} and suggest the required pause time T_{PAUSE}. Furthermore, this response method is achieved by directly writing to the pop block DM_{POP} via the DMA controller 150, without needing to change ready signals (e.g., an RREADY signal) on the advanced peripheral bus B_{APB}, which can prevent head-of-line blocking issues on the advanced peripheral bus B_{APB}.

On the other hand, if in step S203, the buffer manager 140 determines that the number of available pointers NPTR in the register 142 is sufficient, in the example shown in FIG. 1, the register 142 still has four available pointers PTR1-PTR4. Therefore, the buffer manager 140 determines that the number of available pointers NPTR is 4, which can satisfy the pop command (requesting 2 pointers). Proceeding to step S204, the buffer manager 140 pops a current pointer from the register 142, which means retrieving one of the pointers from the register 142. Here, it is assumed that the popped current pointer is pointer PTR1 corresponding to the packet buffer space BUF1.

In this example, the pop command is a burst pop command for two pointers. The current pointer being processed corresponds to the first popped pointer and does not correspond to the last pointer to be popped for the burst pop command.

Next, proceeding to step S205, the buffer manager 140 updates the number of available pointers N_{PTR} to 3, so that the number of available pointers N_{PTR} immediately reflects the current number of available pointers in the register 142.

Reference is further made to FIG. 3C, which is a schematic diagram illustrating the buffer manager 140 writing to the pop block DM_{POP} when the number of available pointers N_{PTR} in the register 142 is sufficient. As shown in FIGS. 1, 2, and 3C, the buffer manager 140 performs step S206, integrating and writing a second state value ST2, a partial pointer address PADD1 of the pointer PTR1, and the number of available pointers N_{PTR} into the pop block DM_{POP}.

As shown in FIG. 3C, because the current pointer (the first pop in a burst pop) does not correspond to the last pointer to be popped for the burst pop command, the buffer manager 140 writes the second state value ST2 into the high-bit portion P_{M} of the pop block DM_{POP}, writes the partial pointer address PADD1 of the pointer PTR1 into a middle-bit portion P_{I} of the pop block DM_{POP}, and writes the updated number of available pointers N_{PTR} into the low-bit portion P_{L} of the pop block DM_{POP}.

As shown in FIG. 3C, the buffer manager 140 integrates and writes the second state value ST2, the partial pointer address PADD1, and the number of available pointers N_{PTR} into the pop block DM_{POP}. The length of the integrated pop block DM_{POP} is 32 bits, which is the same as the length of the original pointer PTR1. In this embodiment, the middle-bit portion P_{I} of the pop block DM_{POP} can be used to transmit the actual variable effective bits of the original pointer PTR1 (i.e., the partial pointer address PADD1). Compared to only transmitting the original pointer PTR1 to the processing unit 110, this pop block DM_{POP} carries three types of information (i.e., the second state value ST2, the partial pointer address PADD1, and the number of available pointers N_{PTR}) using the same data length. In step S208, the data memory 120 updates the pop block DM_{POP} based on the write from the DMA controller 150.

The processing unit 110 performs step S208 to poll and read the pop block DM_{POP} of the data memory 120. It then performs step S209 to identify the value of the high-bit portion P_{M} of the pop block DM_{POP}. If in step S209, the processing unit 110 identifies the value of the high-bit portion P_{M} of the pop block DM_{POP} as 2, which is equal to the second state value ST2 (see FIG. 3C), it indicates that the buffer manager 140 has allocated pointer PTR1 for use by the processing unit 110. At this time, the processing unit 110 performs step S211, obtaining the full address of the original pointer PTR1 from the partial pointer address PADD1 recorded in the middle-bit portion P_{I} of the pop block DM_{POP}, and uses the current pointer (i.e., pointer PTR1).

At this point, because the high-bit portion P_{M} of the pop block DM_{POP} is the second state value ST2, the processing unit 110 can know from the second state value ST2 that the burst pop command has not been fully completed. The processing unit 110 continues to perform step S208, continuously polling and reading the pop block DM_{POP}.

Since the pop command in the above embodiment is a burst pop for two pointers, the buffer manager 140 will perform steps S204 to S206 again. The current pointer being processed now corresponds to the second popped pointer, which is the last pointer to be popped for the burst pop command.

Proceeding to step S204, the buffer manager 140 pops a current pointer from the register 142, which means retrieving another pointer from the register 142. Here, it is assumed that the popped current pointer is pointer PTR2 corresponding to the packet buffer space BUF2.

Next, proceeding to step S205, the buffer manager 140 updates the number of available pointers N_{PTR} to 2, so that the number of available pointers N_{PTR} immediately reflects the current number of available pointers in the register 142.

Reference is further made to FIG. 3D, which is a schematic diagram illustrating the buffer manager 140 writing to the pop block DM_{POP} again when the number of available pointers N_{PTR} in the register 142 is sufficient. As shown in FIGS. 1, 2, and 3D, the buffer manager 140 performs step S206, integrating and writing a third state value ST3, a partial pointer address PADD2 of the pointer PTR2, and the number of available pointers N_{PTR} into the pop block DM_{POP}.

As shown in FIG. 3D, because the current pointer (the second pop in a burst pop) corresponds to the last pointer to be popped for the burst pop command, the buffer manager 140 writes the third state value ST3 into the high-bit portion P_{M} of the pop block DM_{POP}, writes the partial pointer address PADD2 of the pointer PTR2 into the middle-bit portion P_{I} of the pop block DM_{POP}, and writes the updated number of available pointers N_{PTR} into the low-bit portion P_{L} of the pop block DM_{POP}.

The processing unit 110 performs step S208 and step S209. In step S209, if the processing unit 110 identifies the value of the high-bit portion P_{M} of the pop block DM_{POP} as 3, which is equal to the third state value ST3 (see FIG. 3D), it indicates that the buffer manager 140 has allocated pointer PTR2 for use by the processing unit 110. At this time, the processing unit 110 performs step S212, obtaining the full address of the original pointer PTR2 from the partial pointer address PADD2 recorded in the middle-bit portion P_{I} of the pop block DM_{POP}, and uses the current pointer (i.e., pointer PTR2).

At this point, because the high-bit portion P_{M} of the pop block DM_{POP} is the third state value ST3, the processing unit 110 can know from the third state value ST3 that the burst pop command has been fully completed. The processing unit 110 can then stop polling and reading the pop block DM_{POP}.

Through the above mechanism, when the number of available pointers N_{PTR} is sufficient, the buffer manager 140 can proactively respond with the address of the available pointer and the number of remaining available pointers. By directly writing to the pop block DM_{POP} via the DMA controller 150, it can notify the processing unit 110 of the status of the pointer pop, without needing to change ready signals (e.g., an RREADY signal) on the advanced peripheral bus B_{APB}, which can prevent head-of-line blocking issues on the advanced peripheral bus B_{APB}. The processing unit 110 can learn the address of the currently allocated pointer by polling the pop block DM_{POP} in the data memory 120.

The above embodiment describes the process for popping available pointers, but the present disclosure is not limited to popping. It can also be applied to the practice of pushing pointers into the register 142 of the buffer manager 140 when returning pointers.

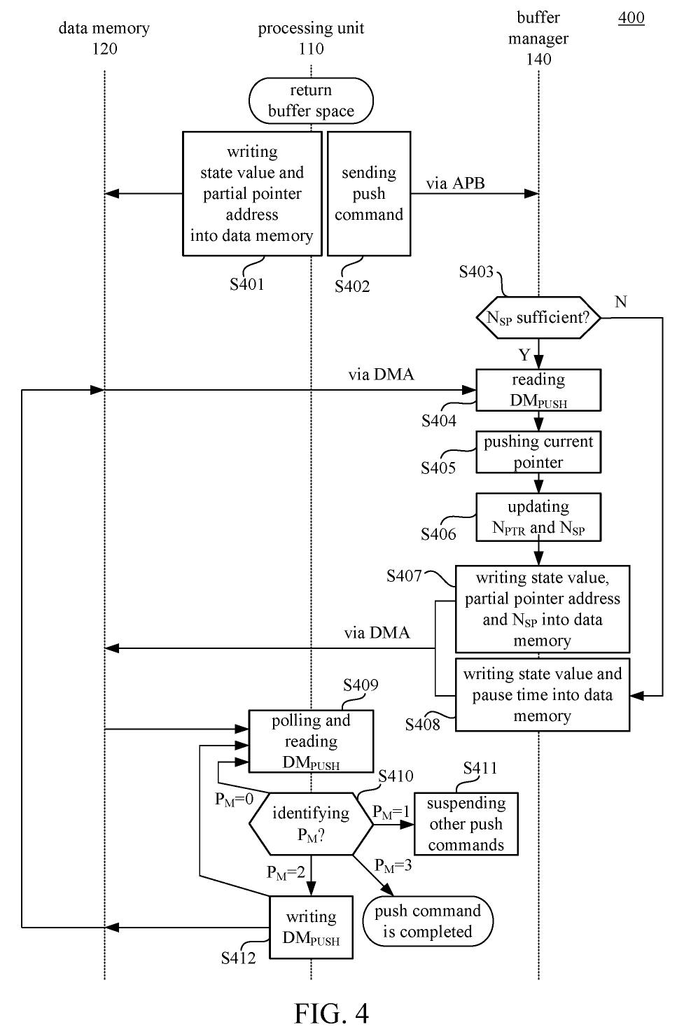

Reference is further made to FIG. 4, which is a flowchart diagram illustrating a control method 400 employed when the processing unit 110 in FIG. 1 wants to release a buffer space and sends a push command to the buffer manager 140.

When the processing unit 110 has finished using a buffer space and wants to return it, the processing unit 110 needs to send a request to the buffer manager 140 to push a pointer.

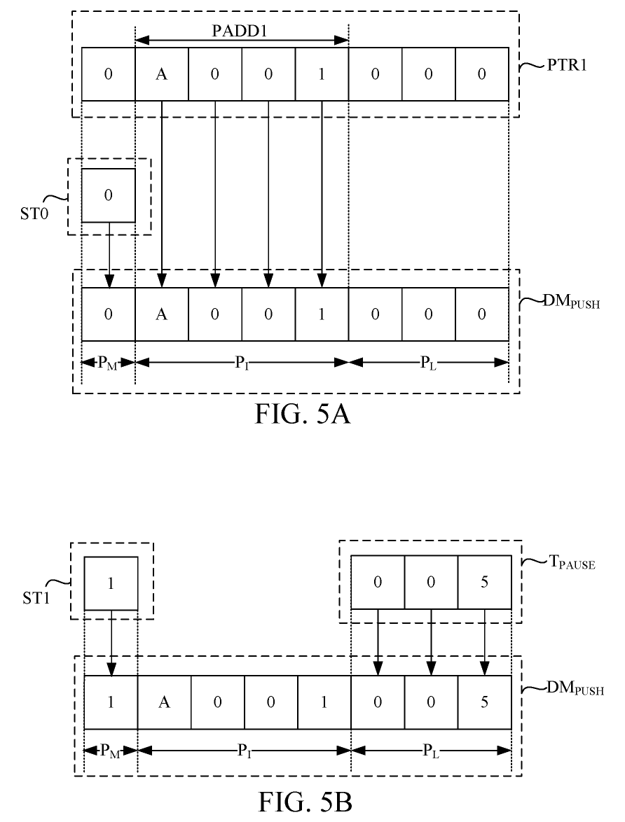

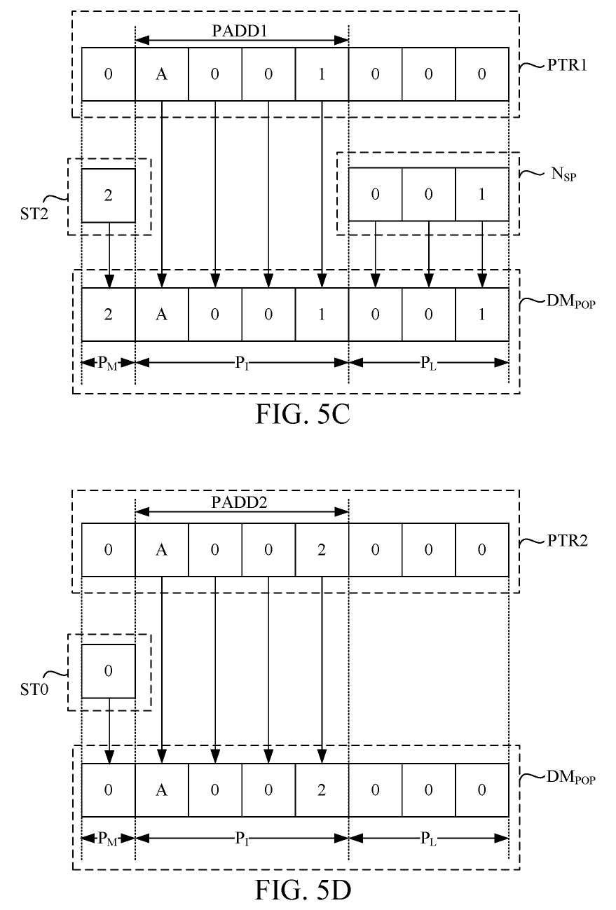

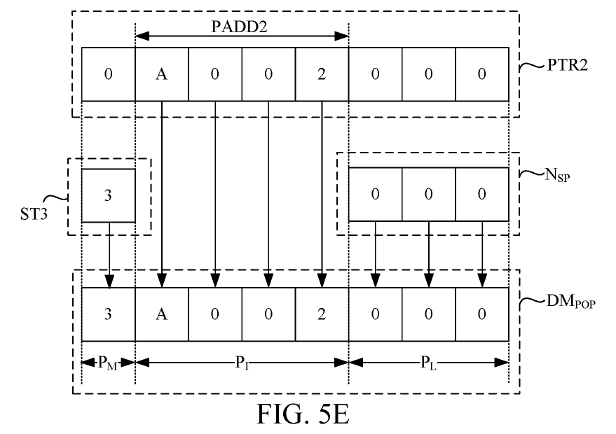

In step S401, the processing unit 110 writes an initial state value and a partial pointer address of the current pointer to be returned into a push block DM_{PUSH} of the data memory 120. Reference is further made to FIG. 5A, which is a schematic diagram illustrating the processing unit 110 writing the initial state value ST0 and the partial pointer address PADD1 of the current pointer to be returned into the push block DM_{PUSH} of the data memory 120.

Assume the processing unit 110 intends to perform a burst push command to sequentially return pointer PTR1 and pointer PTR2. First, the processing unit 110 plans to push pointer PTR1. As shown in FIG. 5A, in step S401, the processing unit 110 writes the initial state value ST0 into the high-bit portion P_{M} of the push block DM_{PUSH} and writes the partial pointer address PADD1 of the current pointer to be pushed (assumed to be pointer PTR1 at this time) into the middle-bit portion P_{I} of the push block DM_{PUSH} of the data memory 120.

The processing unit 110 performs step S402, where the processing unit 110 sends a push command to the buffer manager 140. It is assumed here that the processing unit 110 wants to return two packet buffer spaces, so the push command can be a burst push command to sequentially return pointer PTR1 and pointer PTR2.

In one embodiment, this push command is sent from the processing unit 110 to the buffer manager 140 through the AXI bus B_{AXI}, the bridge 160, the advanced peripheral bus B_{APB}, and via the APB channel C_{APB}.

When the buffer manager 140 receives the push command, it performs step S403 to determine whether the number of remaining spaces N_{SP} in the current register 142 is sufficient. The number of remaining spaces N_{SP} is the total number of pointers the register 142 can hold minus the number of available pointers N_{PTR}.

For example, if the register 142 has a capacity of four pointers and currently stores four available pointers, the register 142 is considered full. In this state, the number of remaining spaces N_{SP} is zero. When the buffer manager 140 determines that the number of remaining spaces N_{SP} in the register 142 is insufficient, the buffer manager 140 performs step S408, writing a first state value and a pause time into the push block DM_{PUSH} via the DMA controller 150. Reference is further made to FIG. 5B, which is a schematic diagram illustrating the buffer manager 140 writing to the push block DM_{PUSH} when the number of remaining spaces N_{SP} in the register 142 is insufficient.

As shown in FIGS. 1, 4, and 5B, when the buffer manager 140 determines that the number of remaining spaces N_{SP} in the register 142 is insufficient, the buffer manager 140 performs step S408, writing a first state value ST1 and a pause time T_{PAUSE} into the push block DM_{PUSH} of the data memory 120 via the DMA controller 150 through the AXI write channel C_{AXIW}. The buffer manager 140 writes the first state value ST1 into the high-bit portion P_{M} of the push block DM_{PUSH} and writes the pause time T_{PAUSE} into the low-bit portion P_{L} of the push block DM_{PUSH}. The push block DM_{PUSH} is updated with the write from the DMA controller 150.

In this embodiment, after the processing unit 110 sends the push command (via the advanced peripheral bus B_{APB} and the APB channel C_{APB}), the processing unit 110 does not need to poll the advanced peripheral bus B_{APB} or wait for the buffer manager 140 to respond via the APB channel C_{APB} on whether the push was successful. After sending the push command, the processing unit 110 can perform step S409, where the processing unit 110 polls and reads the push block DM_{PUSH} of the data memory 120. It then performs step S410 to identify the value of the high-bit portion P_{M} of the push block DM_{PUSH}.

In one embodiment, the processing unit 110 and the data memory 120 have a direct message exchange channel, and they can also communicate via the AXI bus B_{AXI}, without needing to communicate through the advanced peripheral bus B_{APB}. The speed at which the processing unit 110 polls and reads the push block DM_{PUSH} of the data memory 120 (typically requiring only one system clock cycle) is higher than the speed at which the processing unit 110 polls and reads the advanced peripheral bus B_{APB} (typically requiring 2-10 system clock cycles). Therefore, by using the value of the high-bit portion P_{M}, the processing unit 110 can more efficiently learn the processing status of the current push command, without being affected by the advanced peripheral bus B_{APB} being occupied with transmitting other information.

If in step S410, the processing unit 110 identifies the value of the high-bit portion P_{M} of the push block DM_{PUSH} as 0, which is equal to the initial state value ST0 (see FIG. 5A), it indicates that the push command is still in the initial stage and the buffer manager 140 has not yet responded.

If in step S410, the processing unit 110 identifies the value of the high-bit portion P_{M} of the push block DM_{PUSH} as 1, which is equal to the first state value ST1 (see FIG. 5B), it indicates that the buffer manager 140 has responded that the number of remaining spaces N_{SP} is insufficient and cannot meet the demand of the push command. At this time, the processing unit 110 performs step S411, suspending the transmission of other push commands according to the pause time T_{PAUSE} recorded in the low-bit portion P_{L} of the push block DM_{PUSH}. In the embodiment of FIG. 5B, the pause time T_{PAUSE} is 5, indicating that the buffer manager 140 has replied with a request for the processing unit 110 to wait for 5 units of system time. Through this mechanism, the buffer manager 140 can proactively respond to the situation of an insufficient number of remaining spaces N_{SP} and suggest the required pause time T_{PAUSE}. Furthermore, this response method is achieved by directly writing to the push block DM_{PUSH} via the DMA controller 150, without needing to change ready signals on the advanced peripheral bus B_{APB}, which can prevent head-of-line blocking issues on the advanced peripheral bus B_{APB}.

On the other hand, if in step S403, the buffer manager 140 determines that the number of remaining spaces N_{SP} in the register 142 is sufficient, assuming the register 142 still has enough remaining space to accommodate two pointers, the buffer manager 140 determines that the number of remaining spaces N_{SP} is 2, which can satisfy the push command (requesting to return 2 pointers). Proceeding to step S404, the buffer managermanager 140ly reads the push block DM_{PUSH} of the data memory 120 (see FIG. 5A) via the AXI read channel C_{AXIR} and the DMA controller 150. The buffer managermanager 140tain the partial pointer address PADD1 of the current pointer to be pushed (assumed to be pointer PTR1 at this time) from the middle-bit portion P_{I} of the push block DM_{PUSH}, and thereby obtain the full address of the pointer PTR1 to be pushed.

Next, proceeding to step S405, the buffer manager 140 pushes the pointer PTR1 into the register 142. In this way, the pointer PTR1 is successfully released and can be reused by subsequent commands. At this time, the buffer manager 140 performs step S406, updating the number of available pointers N_{PTR} to 3 and the number of remaining spaces N_{SP} to 1, so that both N_{PTR} and N_{SP} immediately reflect the current state of the register 142.

Reference is further made to FIG. 5C, which is a schematic diagram illustrating the buffer manager 140 writing to the push block DM_{PUSH} when the number of remaining spaces N_{SP} in the register 142 is sufficient. As shown in FIGS. 1, 4, and 5C, the buffer manager 140 performs step S407, integrating and writing a second state value ST2, the partial pointer address PADD1 of pointer PTR1, and the number of remaining spaces N_{SP} into the push block DM_{PUSH}.

As shown in FIG. 5C, because the current pointer (the first push in a burst push) does not correspond to the last pointer to be pushed for the burst push command, the buffer manager 140 writes the second state value ST2 into the high-bit portion P_{M} of the push block DM_{PUSH}, writes the partial pointer address PADD1 of pointer PTR1 into the middle-bit portion P_{I} of the push block DM_{PUSH}, and writes the updated number of remaining spaces N_{SP} into the low-bit portion P_{L} of the push block DM_{PUSH}.

As shown in FIG. 5C, the buffer manager 140 integrates and writes the second state value ST2, the partial pointer address PADD1, and the number of remaining spaces N_{SP} into the push block DM_{PUSH}. The length of the integrated push block DM_{PUSH} is 32 bits, which is the same as the length of the original pointer PTR1. In this embodiment, the middle-bit portion P_{I} of the push block DM_{PUSH} can be used to transmit the actual variable effective bits of the original pointer PTR1 (i.e., the partial pointer address PADD1).

The processing unit 110 performs step S409 to poll and read the push block DM_{PUSH} of the data memory 120. It then performs step S410 to identify the value of the high-bit portion P_{M} of the push block DM_{PUSH}. If in step S410, the processing unit 110 identifies the value of the high-bit portion P_{M} of the push block DM_{PUSH} as 2 and the middle-bit portion P_{I}as the partial pointer address PADD1 of pointer PTR1, which is equal to the second state value ST2 (see FIG. 5C), it indicates that the buffer manager 140 has completed the push-and-return of pointer PTR1, i.e., the first push in the burst push is complete.

The processing unit 110 can then proceed with the next push in the burst push. Reference is further made to FIG. 5D, which is a schematic diagram illustrating the processing unit 110 writing the initial state value ST0 and the partial pointer address PADD2 of the current pointer PTR2 (subsequent to the pointer PTR1) to be returned into the push block DM_{PUSH} of the data memory 120. In step S412, the initial state value ST0 is written into the high-bit portion P_{M} of the push block DM_{PUSH}, and the partial pointer address PADD2 of the current pointer to be pushed (assumed to be pointer PTR2 at this time) is written into the middle-bit portion P_{I} of the push block DM_{PUSH} of the data memory 120.

At this point, the push block DM_{PUSH} is updated with the write from the processing unit 110. Since the push command in the above embodiment is a burst push for two pointers, the buffer manager 140 will perform steps S404 to S407 again. The current pointer being processed now corresponds to the second pointer to be pushed, which is the last pointer to be pushed for the burst push command.

Proceeding to step S404, the buffer manager 140 directly reads the push block DM_{PUSH} of the data memory 120 (see FIG. 5D) via the AXI read channel C_{AXIR} and the DMA controller 150. The buffer manager 140 can obtain the partial pointer address PADD2 of the current pointer to be pushed (assumed to be pointer PTR2 at this time) from the middle-bit portion P_{I} of the push block DM_{PUSH}, and thereby obtain the full address of the pointer PTR2 to be pushed.

Next, proceeding to step S405, the buffer manager 140 pushes the pointer PTR2 into the register 142. In this way, the pointer PTR2 is successfully released and can be reused by subsequent commands. At this time, the buffer manager 140 performs step S406, updating the number of available pointers N_{PTR} to 4 and the number of remaining spaces N_{SP} to 0, so that both N_{PTR} and N_{SP} immediately reflect the current state of the register 142.

Reference is further made to FIG. 5E, which is a schematic diagram illustrating the buffer manager 140 writing to the push block DM_{PUSH} when the number of remaining spaces N_{SP} in the register 142 is sufficient. As shown in FIGS. 1, 4, and 5E, the buffer manager 140 performs step S407, integrating and writing a third state value ST3, the partial pointer address PADD2 of pointer PTR2, and the number of remaining spaces N_{SP} into the push block DM_{PUSH}.

As shown in FIG. 5E, because the current pointer (the second push in a burst push) corresponds to the last pointer to be pushed for the burst push command, the buffer manager 140 writes the third state value ST3 into the high-bit portion P_{M} of the push block DM_{PUSH}, writes the partial pointer address PADD2 of pointer PTR2 into the middle-bit portion P_{I} of the push block DM_{PUSH}, and writes the updated number of remaining spaces N_{SP} into the low-bit portion P_{L} of the push block DM_{PUSH}.

The processing unit 110 performs step S409 and step S410. In step S410, if the processing unit 110 identifies the value of the high-bit portion P_{M} of the push block DM_{PUSH} as 3, which is equal to the third state value ST3 (see FIG. 5E), it indicates that the buffer manager 140 has pushed pointer PTR2. At this time, because the high-bit portion P_{M} of the push block DM_{PUSH} is the third state value ST3, the processing unit 110 determines from the third state value ST3 that the current pointer PTR2 has been successfully returned and that the burst push command has been fully completed. The processing unit 110 can then stop polling and reading the push block DM_{PUSH}.

Through the above mechanism, when the number of remaining spaces N_{SP} is sufficient, the buffer manager 140 can read the push block DM_{PUSH} and learn the address of the pointer to be pushed from it. When the pointer push is complete, the buffer manager 140 can proactively respond with the number of remaining spaces N_{SP} and directly write it into the push block DM_{PUSH} via the DMA controller 150, thereby notifying the processing unit 110 of the status of the pointer push. During this process, there is no need to change ready signals on the advanced peripheral bus B_{APB}, which can prevent head-of-line blocking issues on the advanced peripheral bus B_{APB}. The processing unit 110 can learn whether the pointer push is complete and the number of remaining spaces N_{SP} in the register 142 by polling the push block DM_{PUSH} in the data memory 120.

Although the present disclosure has been disclosed in terms of the above embodiments, these embodiments are not intended to limit the present disclosure. Various modifications and improvements can be made by those skilled in the art without departing from the spirit and scope of the present disclosure. Therefore, the scope of protection of the present disclosure shall be defined by the appended claims.

What is claimed is:

1. An electronic apparatus, comprising:
a data memory;
a direct memory access controller, coupled to the data memory;
a processing unit, coupled to the data memory;
a buffer memory, having a plurality of packet buffer spaces, wherein the plurality of packet buffer spaces are respectively aligned with a packet size; and
a buffer manager, comprising a register configured to temporarily store a plurality of pointers, the plurality of pointers being for indicating start addresses of the plurality of packet buffer spaces, the buffer manager being configured to manage the plurality of pointers and monitor a number of available pointers in the register,
wherein the processing unit is configured to write an initial state value into a pop block of the data memory and send a pop command to the buffer manager,
in response to the pop command, when the buffer manager determines that the number of available pointers is insufficient, the buffer manager is configured to write a first state value and a pause time into the pop block via the direct memory access controller.

2. The electronic apparatus of claim 1, wherein the buffer manager is configured to write the first state value into a high-bit portion of the pop block and write the pause time into a low-bit portion of the pop block.

3. The electronic apparatus of claim 1, wherein in response to the pop command, when the buffer manager determines that the number of available pointers is sufficient, the buffer manager is configured to pop a current pointer from the register and update the number of available pointers, and the buffer manager is configured to write a second state value or a third state value, a partial pointer address of the current pointer, and an updated number of available pointers into the pop block via the direct memory access controller.

4. The electronic apparatus of claim 3, wherein the buffer manager is configured to write the second state value or the third state value into a high-bit portion of the pop block, write the partial pointer address of the current pointer into a middle-bit portion of the pop block, and write the number of available pointers into a low-bit portion of the pop block.

5. The electronic apparatus of claim 4, wherein the pop command is a burst pop command,
if the current pointer popped by the buffer manager corresponds to a last pointer to be popped for the burst pop command, the buffer manager is configured to write the third state value into the high-bit portion of the pop block; and
if the current pointer does not correspond to the last pointer to be popped for the burst pop command, the buffer manager is configured to write the second state value into the high-bit portion of the pop block.

6. The electronic apparatus of claim 5, wherein after the processing unit sends the pop command to the buffer manager, the processing unit is configured to poll and read the pop block and identify the high-bit portion of the pop block,
when the high-bit portion of the pop block is identified as the first state value, the processing unit is configured to pause the pop command;
when the high-bit portion of the pop block is identified as the second state value, the processing unit is configured to use the current pointer and continue to poll and read the pop block; and
when the high-bit portion of the pop block is identified as the third state value, the processing unit is configured to use the current pointer and stop polling and reading the pop block.

7. The electronic apparatus of claim 6, wherein the processing unit is configured to send the pop command to the buffer manager via an advanced peripheral bus, and a first speed at which the processing unit polls and reads the pop block of the data memory is higher than a second speed at which the processing unit polls and reads the advanced peripheral bus.

8. The electronic apparatus of claim 1, wherein the processing unit is configured to write the initial state value and a partial pointer address of a current pointer into a push block of the data memory, and the processing unit is configured to send a push command to the buffer manager,
in response to the push command, when the buffer manager determines that a number of remaining spaces in the register is insufficient, the buffer manager is configured to write the first state value and the pause time into the push block via the direct memory access controller.

9. The electronic apparatus of claim 8, wherein the buffer manager is configured to write the first state value into a high-bit portion of the push block and write the pause time into a low-bit portion of the push block.

10. The electronic apparatus of claim 8, wherein in response to the push command, when the buffer manager determines that the number of remaining spaces is sufficient, the buffer manager is configured to read the push block via the direct memory access controller, push the current pointer into the register according to the partial pointer address of the current pointer, update the number of remaining spaces, and write a second state value or a third state value, the partial pointer address of the current pointer, and an updated number of remaining spaces into the push block via the direct memory access controller.

11. The electronic apparatus of claim 10, wherein the buffer manager is configured to write the second state value or the third state value into a high-bit portion of the push block, write the partial pointer address of the current pointer into a middle-bit portion of the push block, and write the number of remaining spaces into a low-bit portion of the push block.

12. The electronic apparatus of claim 11, wherein the push command is a burst push command,
if the current pointer pushed by the buffer manager corresponds to a last pointer to be pushed for the burst push command, the buffer manager is configured to write the third state value into the high-bit portion of the push block; and
if the current pointer does not correspond to the last pointer to be pushed for the burst push command, the buffer manager is configured to write the second state value into the high-bit portion of the push block.

13. The electronic apparatus of claim 12, wherein after the processing unit sends the push command to the buffer manager, the processing unit is configured to poll and read the push block and identify the high-bit portion of the push block,
when the high-bit portion of the push block is identified as the first state value, the processing unit is configured to pause the push command;
when the high-bit portion of the push block is identified as the second state value, the processing unit is configured to determine that the current pointer is successfully returned, write the initial state value and a partial pointer address of a subsequent pointer into the push block of the data memory, and continue to poll and read the push block; and
when the high-bit portion of the push block is identified as the third state value, the processing unit is configured to determine that the current pointer is successfully returned and the push command is completed, and stop polling and reading the push block.

14. A control method, comprising:
writing, by a processing unit, an initial state value into a pop block of a data memory, and sending, by the processing unit, a pop command to a buffer manager;
in response to the pop command, determining, by the buffer manager, whether a number of available pointers in a register is sufficient; and
when the buffer manager determines that the number of available pointers is insufficient, writing, by the buffer manager, a first state value and a pause time into the pop block via a direct memory access controller.

15. The control method of claim 14, wherein when the buffer manager determines that the number of available pointers is sufficient, the control method further comprises:
popping, by the buffer manager, a current pointer from the register and updating the number of available pointers; and
writing, by the buffer manager, a second state value or a third state value, a partial pointer address of the current pointer, and an updated number of available pointers into the pop block via the direct memory access controller.

16. The control method of claim 15, wherein the pop command is a burst pop command,
if the current pointer popped by the buffer manager corresponds to a last pointer to be popped for the burst pop command, writing, by the buffer manager, the third state value into a high-bit portion of the pop block; and
if the current pointer does not correspond to the last pointer to be popped for the burst pop command, writing, by the buffer manager, the second state value into the high-bit portion of the pop block.

17. The control method of claim 16, wherein after sending, by the processing unit, the pop command to the buffer manager, the control method further comprises:
polling and reading, by the processing unit, the pop block, and identifying a high-bit portion of the pop block;
when the high-bit portion of the pop block is identified as the first state value, pausing, by the processing unit, the pop command;
when the high-bit portion of the pop block is identified as the second state value, using, by the processing unit, the current pointer, and continuing to poll and read the pop block; and
when the high-bit portion of the pop block is identified as the third state value, using, by the processing unit, the current pointer, and stopping polling and reading the pop block.

18. A control method, comprising:
writing, by a processing unit, an initial state value and a partial pointer address of a current pointer into a push block of a data memory, and sending, by the processing unit, a push command to a buffer manager;
in response to the push command, determining, by the buffer manager, whether a number of remaining spaces in a register is sufficient; and
when the buffer manager determines that the number of remaining spaces is insufficient, writing, by the buffer manager, a first state value and a pause time into the push block via a direct memory access controller.

19. The control method of claim 18, wherein when the buffer manager determines that the number of remaining spaces is sufficient, the control method further comprises:
reading, by the buffer manager, the push block via the direct memory access controller;
pushing, by the buffer manager, the current pointer into the register according to the partial pointer address of the current pointer, and updating the number of remaining spaces; and
writing, by the buffer manager, a second state value or a third state value, the partial pointer address of the current pointer, and an updated number of remaining spaces into the push block.

20. The control method of claim 19, wherein after sending, by the processing unit, the push command to the buffer manager, the control method further comprises:
polling and reading, by the processing unit, the push block, and identifying a high-bit portion of the push block;
when the high-bit portion of the push block is identified as the first state value, pausing, by the processing unit, the push command;
when the high-bit portion of the push block is identified as the second state value, determining, by the processing unit, that the current pointer is successfully returned, writing, by the processing unit, the initial state value and a partial pointer address of a subsequent pointer into the push block of the data memory, and continuing to poll and read the push block; and
when the high-bit portion of the push block is identified as the third state value, determining, by the processing unit, that the current pointer is successfully returned and the push command is completed, and stopping polling and reading the push block.
